(19) United States
(12) Patent Application Publication
(10) Pub. No.: US 2009/0316445 A1
(43) Pub. Date: Dec. 24, 2009

(54) High Voltage Power Supply

(76) Inventors: Matthew E. Mowrer, St. Clairsville, OH (US); James E. Dvorsky, Norwich Township, OH (US); James J. Lind, Lenexa, KS (US); Stephen R. Schulte, Gibsonia, PA (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 12/306,100

(22) PCT Filed: Jun. 26, 2007
(86) PCT No.: PCT/US07/14816

§ 371 Date: Jun. 17, 2009

Related U.S. Application Data
(60) Provisional application No. 60/816,418, filed on Jun. 26, 2006.
(60) Provisional application No. 60/881,261, filed on Jan. 19, 2007.

(51) Int. Cl. H02M 3/335

(52) U.S. Cl. 363/21.17

(57) ABSTRACT

This invention pertains to the control of high voltage power, and in particular to control of high voltage power from low voltage sources while reducing unwanted self resonance in the windings of a self oscillating flyback converter.

### BACKGROUND OF THE INVENTION

This invention relates in general to the control of high voltage power supplies, and in particular to consistent control of high voltage power from low voltage sources.

A High Voltage Power Supply (HVPS) commonly provides inconsistent output voltage which is inefficient and wasteful. This is particularly true when the HVPS is powered by a source such as batteries, which decline in performance over time. A consistent, high output voltage which is low cost and efficient is desired. Low cost, efficient, consistent and compact high voltage components are particularly desired for commercial applications, and in particular for electro-hydrodynamic spraying of materials.

### SUMMARY OF THE INVENTION

This invention relates to consistent control of high voltage power from low voltage sources.

The present invention contemplates a High Voltage Power Supply (HVPS) that includes a flyback transformer having a primary winding and a feedback winding, the primary winding having a first end adapted to be connected to a power source. The HVPS also includes a switching device connected between a second end of the primary winding and ground, the switching device having a control port connected to a first end of the feedback winding. The HVPS further includes a compensation capacitor connected between the switching device control port and ground.

The present invention also contemplates another embodiment of the above HVPS that includes regulation of the power supply to maintain the output voltage within a voltage range if the output load or input voltage changes. The other embodiment includes first and second switching devices. The first switching device is connected to the second end of the primary winding, as described above, while the second switching device is connected between the first switching device and ground. The second switching device is operable to interrupt current flow to said first switching device to regulate the output voltage. The embodiment also includes feedback of a voltage that is proportional to the output voltage to a voltage regulation device. The voltage regulation device is connected to the second switching device and operable to selectively cause the second switching device to interrupt current flow to said first switching device to regulate operation of the power supply.

Another embodiment of the present invention assumes load changes are small or inconsequential to the output voltage, but changes to the input voltage are expected, as may occur with operation from a battery power source. The embodiment includes feedback from the power source itself to a voltage regulation device. The voltage regulation device is connected to the second switching device and operable to selectively cause the second switching device to interrupt current flow to the first switching device to effectively regulate the voltage of the power source applied to the HVPS.

The present invention also contemplates a method of operating the power supplies described above in which a DC voltage is applied to the switching device which then begins to conduct, causing self-oscillation of the circuit to occur. The self oscillation induces an output voltage in the flyback transformer secondary winding.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a circuit diagram for a High Voltage Power Supply that is in accordance with the invention.

FIG. 2 is a circuit diagram for alternate embodiment of the power supply shown in FIG. 1 showing a Cockcroft-Walton voltage multiplier to rectify and boost the output voltage.

FIG. 3 is a circuit diagram for another alternate embodiment of the power supply shown in FIG. 1 showing the use of an operational amplifier to regulate the output voltage.

FIG. 4 is a circuit diagram for another alternate embodiment of the power supply shown in FIG. 1 showing a microcontroller used to receive and analyze the feedback signal from the high voltage output and accordingly regulate the operation of the power supply to maintain the output voltage.

FIG. 5 as a circuit diagram for another alternate embodiment of the power supply shown in FIG. 1 showing regulation of the input voltage.

FIG. 6 as a circuit diagram for another alternate embodiment of the power supply shown in FIG. 1 also showing regulation of the input voltage.

FIG. 7 as a circuit diagram for another alternate embodiment of the power supply shown in FIG. 1 also showing regulation of the input voltage.

FIG. 8 is an oblique view of the circuit shown in FIG. 4.

FIG. 9 is an oscilloscope screen capture of collector and base voltages for the circuits shown in FIGS. 1 and 2.

FIG. 10 is an oscilloscope screen capture of collector and base voltages for the circuits shown in FIGS. 1 and 2 with the compensating capacitor removed.

FIG. 11 is a graph showing the collector current and output voltage for the circuit configuration shown in FIGS. 1 and 2 as a function of compensation capacitance.

FIG. 12 is an oscilloscope screen capture of voltages occurring within the circuit shown in FIG. 2.

FIG. 13 is an oscilloscope screen capture of voltages occurring within the circuit shown in FIG. 2 with the compensating capacitor removed.

### DETAILED DESCRIPTION OF THE PREFERRED EMBODIMENT

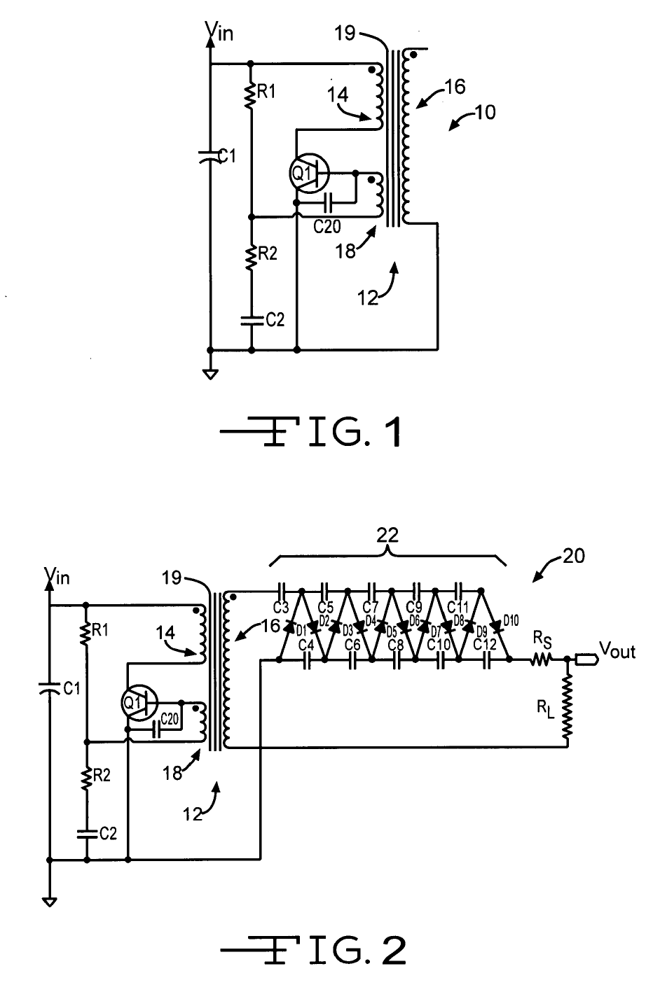

Referring now to the drawings, there is illustrated in FIG. 1a circuit diagram for a High Voltage Power Supply (HVPS) 10 that is in accordance with the invention. The HVPS 10 includes a flyback transformer 12 having primary and secondary windings 14 and 16, respectively, with the secondary winding having more turns than the primary winding. The flyback transformer also includes a feedback winding 18. All three windings 14, 16 and 18 are wound upon a common core 19. The HVPS 10 also includes a switching transistor Q1 that has a collector terminal connected to one end of the primary winding 14 and an emitter terminal connected to ground. The switching transistor Q1 has a base terminal connected through the feedback winding 18 to the common connection of first and second feedback winding bias resistors R1 and R2, respectively. The non-common connection end of the first resistor R1 is connected to a DC power supply Vᵢₙ while the non-common connection end of the second resistor R2 is connected through an tuning capacitor C2 to ground. The tuning capacitor C2 co-operates with the resistors R1 and R2 in the bias voltage divider to provide a time constant that determines the oscillation frequency of the circuit. A large filter capacitor C1 is connected between the power supply Vᵢₙ and ground across the input of the circuit 10. A compensation capacitor C20, the purpose for which will be explained below, is connected between the base and emitter terminals of the switching transistor Q1. Because the switching transistor emitter terminal is connected to ground, the compensation capacitor C20 is also connected between one end of the feedback winding 18 and ground.

The operation of the HVPS 10 will now be explained. When power is applied to the circuit, the bias resistors R1 and R2 cause the switching transistor Q1 to begin to turn on, or conduct, allowing an electric current to flow through the flyback transistor primary winding 14. The primary winding 14 is linked by the transformer core 19 to the feedback winding 18. As current builds in the primary winding 14, a magnetic field is generated in the transformer core 19 that induces a voltage opposed to the conduction of the of the switching transistor Q1 builds within the feedback winding 18. As the feedback winding voltage builds, the switching transistor Q1 turns off causing the current through the primary winding 14 to go to zero. The drop of primary winding current collapses the magnet field generated by the primary winding 14 and thereby induces a voltage in the secondary winding 16. Because the secondary winding 16 has more turns than the primary winding 14, the induced voltage across the secondary winding is greater than the voltage across the primary winding 14, with the magnitude determined by the turn ratio of the secondary winding to primary winding. Once the switching transistor Q1 turns off, or stops conducting, the voltage induced across the feedback winding 18 also drops to zero, allowing the switching transistor Q1 to begin to turn on again, repeating the cycle. Thus the HVPS 10 illustrated in FIG. 1 is a self-oscillating circuit, or self-oscillating converter. Because the HVPS 10 operates by switching the switching transistor Q1 between conducting and non-conducting states, the circuit may also be referred to as a switching power converter.

In a self-oscillating circuit, such as the HVPS 10, the frequency of operation is a function of the load on the power supply, the input voltage magnitude, the inductance of the primary winding the ratio of the number of turns in the feedback and primary windings, the gain of the switching transistor, and the value of capacitor C2. For self-oscillating converters, roughly half of the cycle is devoted to storing energy in the magnetic field of the transformer, and during the other half of the period, the energy is released to the load. Typical switching frequencies are intentionally set to be greater than the normal range of human hearing, that is, greater than 20 kHz, and more specifically, typically 30-50 kHz. By design, the converters have a minimum operating frequency that optimizes the energy transfer into and out of the transformer and minimizes losses in the transistor that occur during switching transitions.

Ideally, the frequency of oscillation of the HVPS 10 is determined by the parameters noted above. However, capacitive coupling between the primary and feedback windings 14 and 18, magnetic and capacitive coupling between the secondary and feedback windings 16 and 18, and capacitances within the windings themselves can have a number of resonant frequencies in the power supply's operation. Capacitance in the high voltage output circuit applied to the secondary winding coupled with the inductance of secondary winding 16 can produce resonant frequencies that are reflected by the feedback winding into the self-oscillating circuit. In most cases, only the intended resonant frequency established by the circuit designer will allow efficient conversion of the electrical energy. Other resonances may cause heating of the windings and other undesired losses.

In order to reduce wasted energy, compensation capacitor C20 functions to filter the voltage signals induced in the feedback winding 18 by the undesired resonant modes. By filtering this feedback signal, the HVPS 10 is able to reduce the number of, or prevent entirely, false triggering of the switching transistor Q1. Each time the switching transistor Q1 triggers, more current is pumped into the primary winding 14 and is then induced in the secondary winding 18 when the field in the primary winding collapses. When a false trigger occurs, two undesirable events occur. First, more current is supplied to the primary winding, perpetuating the unwanted feedback problem and second, each false trigger wastes energy in useless voltage spikes.

The compensation capacitor C20 placed across the base-emitter terminals of the primary switching transistor Q1 shunts high frequency resonant signals around the switching transistor, effectively allowing the transistor to ignore these impulses. However, when the actual drive signal is applied to the base terminal of the switching transistor Q1, the transistor is able to conduct current through its collector-emitter junction as expected. Thus, the switching capacitor C20 filters high, undesired resonant frequencies of the HVPS 10 from the device operation. The compensation capacitor C20 is generally small, typically in the range of 0.01 μF to 0.1 μF, and is selected based on the resonant frequency established by the designer, as well as desired input-output performance. An advantage of the invention is that the compensation capacitor C20 reduces the loss of power within the power supply itself and an optimized value for C20 maximizes conversion efficiency while also maintaining the desired high output voltage.

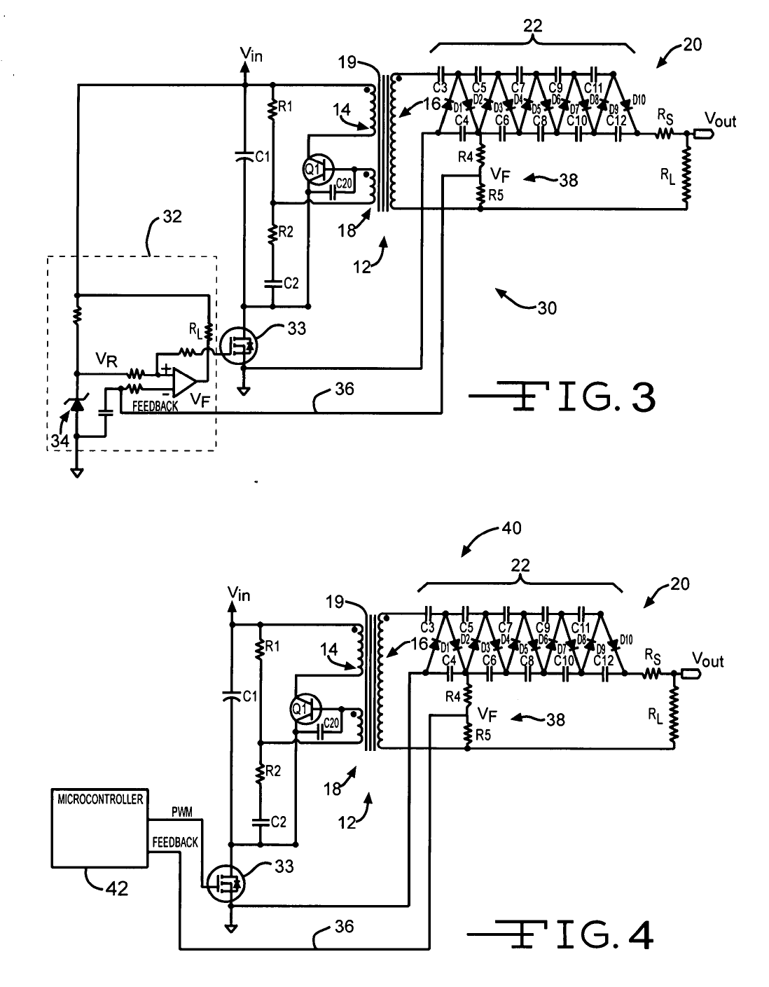

An alternate embodiment of the HVPS 10 is shown generally at 20 in FIG. 2. Components of the HVPS 20 that are similar to components shown in FIG. 1 have the same numerical identifiers. The HVPS 20 includes the self-oscillating circuit described above and illustrated in FIG. 1; however, a conventional Cockcroft-Walton voltage multiplier circuit 22 has been connected across the secondary winding 18 of the flyback transformer 12. The voltage multiplier circuit 22 includes a cascaded series of capacitors and diodes. During operation, the capacitors are cascade charged with each set of two capacitors and two diodes doubling the applied voltage at the output of the secondary winding 16. The output is then the sum of all of the voltages on the individual capacitors. The diodes control the current path through the capacitors to provide a constant output voltage Vₒᵤₜ that has little or no ripple. Since there are five sets of capacitors and diodes, the voltage applied to the input of the voltage multiplier circuit 22 is doubled five times for a total of 10 times for the complete multiplier circuit. In one HVPS circuit built in accordance with the invention, an input voltage V_{IN} of four volts generated a secondary winding voltage of 2 Kv which was then multiplied by ten to produce an output voltage V_{OUT} of 20 Kv.

While the multiplier circuit 22 shown in FIG. 2 includes ten stages, it will be appreciated that the invention also may be practiced with more or less stages than are shown in order to increase or decrease, respectively, the output voltage produced. The final stage of the multiplier circuit 22 is connected to an output resistor R_{S} that limits the output current as a protection for the users. However, the output resistor is optional and, depending upon the application for the HVPS 20, may be omitted. A load, represented by the resistor R_{L} is connected between the output resistor R_{S} and ground.

The self-oscillating HVPS 10 and 20 shown in FIGS. 1 and 2 are unregulated, that is, any variation in the input voltage will result in a change in the output voltage V_{OUT}. Accordingly, another alternate embodiment of the invention is illustrated generally at 30 in FIG. 3 that includes regulation of the output voltage V_{OUT} by controlling the input voltage V_{IN}. As before, components shown in FIG. 3 that are similar to components shown in the preceding Figs. have the same numerical identifiers.

The HVPS 30 includes a comparator circuit 32 having an output that is connected to the gate of an electronic switch, which is shown as a Field Effect Transistor (FET) 33 in FIG. 3. The FET 33 has a source terminal connected to ground and a drain terminal connected to the emitter terminal of the switching transistor Q1. The comparator circuit 32 includes an operational amplifier 34 that has a positive input terminal connected to the anode of a Zener diode 34. The cathode of the Zener diode 34 is connected through a resistor to the input voltage Vᵢₙ while the anode of the Zener diode is connected to ground. Thus, the Zener diode 34 supplies a reference voltage V_{R} to the operational amplifier that is determined by the particular Zener diode that is utilized in the circuit. A feedback line 36 connects the negative terminal of the operational amplifier 32 to the center tap of a voltage divider 38 that is connected between one of the multiplier circuit stages and ground. While the voltage divider is shown as being connected at the tap marked (e), it will be appreciated that the voltage divider also may be connected at any of the other taps shown in FIG. 3, as well as to the output voltage V_{OUT}. Regardless of the location of the feedback voltage divider, the feedback voltage V_{F} is proportional to the output voltage V_{OUT}. Thus the voltage divider 38 supplies a feedback voltage V_{F} to the negative terminal of the operational amplifier 32.

The operation of the regulated HVPS 30 will now be explained. The operational amplifier compares the feedback voltage V_{F} to the reference voltage V_{R}. If the feedback voltage V_{F} is less than the reference voltage V_{R}, the FET gate terminal is held high, placing the FET 33 into its conducting state and allowing current to flow through the input of the self-oscillating flyback circuit, which, in turn, causes the HVPS 30 to generate an output voltage. However, if the feedback voltage V_{F} increases and becomes more than the reference voltage V_{R}, the FET gate terminal is pulled to ground and the FET 33 is switched to its non-conducting state, interrupting the flow of power to the HVPS 30. With the input power switched off, the self-oscillating circuit stops functioning and the output voltage V_{OUT} begins to decrease, causing a similar decrease in the feedback voltage V_{F}. Once the feedback voltage V_{F} falls below the reference voltage V_{R}, the output of the operational amplifier circuits goes high again, causing the FET 33 to switch back to its conducting state to again supply power to the self-oscillating circuit. Thus, the HVPS 30 utilizes on/off control to maintain the output voltage V_{OUT} relative to a predetermined reference voltage. The present invention also contemplates adding hysteresis to the comparator circuit 32 to prevent hunting of the operational amplifier output about the reference voltage, and to ensure the FET 33 is always either fully conducting or non-conducting. A partially conducting FET 33 would increase power dissipation in this portion of the circuit and contribute to inefficiency of the overall HVPS 30 operation. Moreover, establishing two well-defined operating states for FET switch 33 ensures that the self-oscillating flyback converter also has only two operating states.

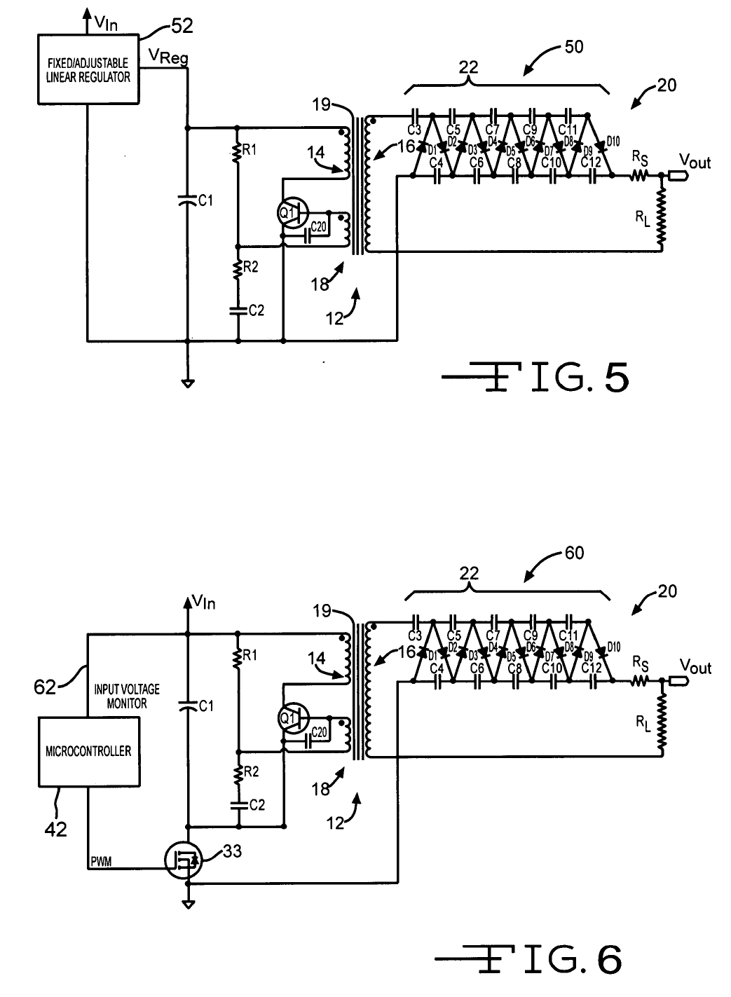

Another alternate embodiment of the invention is shown generally at 40 in FIG. 4, where again components shown that are similar to components shown in the preceding Figs. have the same numerical identifiers. The HVPS 40 is regulated by a microcontroller 42 which may be a programmed microprocessor or an Application Specific Integrated Circuit (ASIC). As shown in FIG. 4, the feedback line 36 is connected to a feedback voltage port on the microprocessor 42 while the gate terminal of the FET 33 is connected to a control port on the microprocessor. The invention contemplates that the microprocessor 42 is operative to apply a constant frequency Pulse Width Modulated (PWM) voltage to the gate terminal of the FET 33. The PWM voltage is used to control the effective input voltage to the HVPS 40. This control is facilitated by dynamically varying the ratio of the on-time of the HVPS input voltage signal to the off-time, that is, the duty cycle of the PWM voltage. The microprocessor 40 may be programmed to regulate the output voltage V_{OUT} to be maintained at a specified voltage. Thus, inclusion of the microprocessor 40 allows setting the output voltage without changing circuit components. Hysteresis is added through software included in the microprocessor 42 to prevent high frequency switching at very small variations around the reference voltage.

Alternatively, the operation of the microprocessor 42 may employ fixed on or off times and a variable frequency in the PWM signal applied to the gate terminal of the FET 33.

The preceding embodiments of the invention all utilize sensing of the output voltage and adjusting input parameters to maintain a constant output voltage. As already described, output voltage feedback has the advantage of compensating for variations in load, as well as supply voltage. However, if the intended high voltage load is reasonably constant, then the supply only needs to compensate for variations in supply voltage, such as that to be expected with battery sources. Accordingly, the present invention contemplates additional embodiments for which it is assumed that the performance of the power supply itself is known and constant; that is, a specific supply voltage (Vin) is applied to the self-oscillating circuit and the transformer primary will produce a specific high voltage output. Under these conditions, the supplied voltage may be pre-regulated prior to being delivered to the oscillator and transformer.

An alternate embodiment of the invention that utilizes regulation of the input power supply is illustrated generally at 50 in FIG. 5, where components that are similar to components shown in the preceding figures have the same numerical identifiers. As shown in FIG. 5, the HVPS 50 includes a voltage regulator 52 that is inserted between the power source, such as, for example, batteries, etc., and the high voltage power supply. The voltage regulator 52 may be a conventional linear voltage regulator or a conventional switching voltage regulator. While a switching regulator is more efficient than a linear regulator, the cost and complexity of the switching regulator is greater than that of the linear regulator. As an example, the circuitry shown in FIGS. 5 through 7 will yield 25 kVDC when the input supply is 4 VDC.

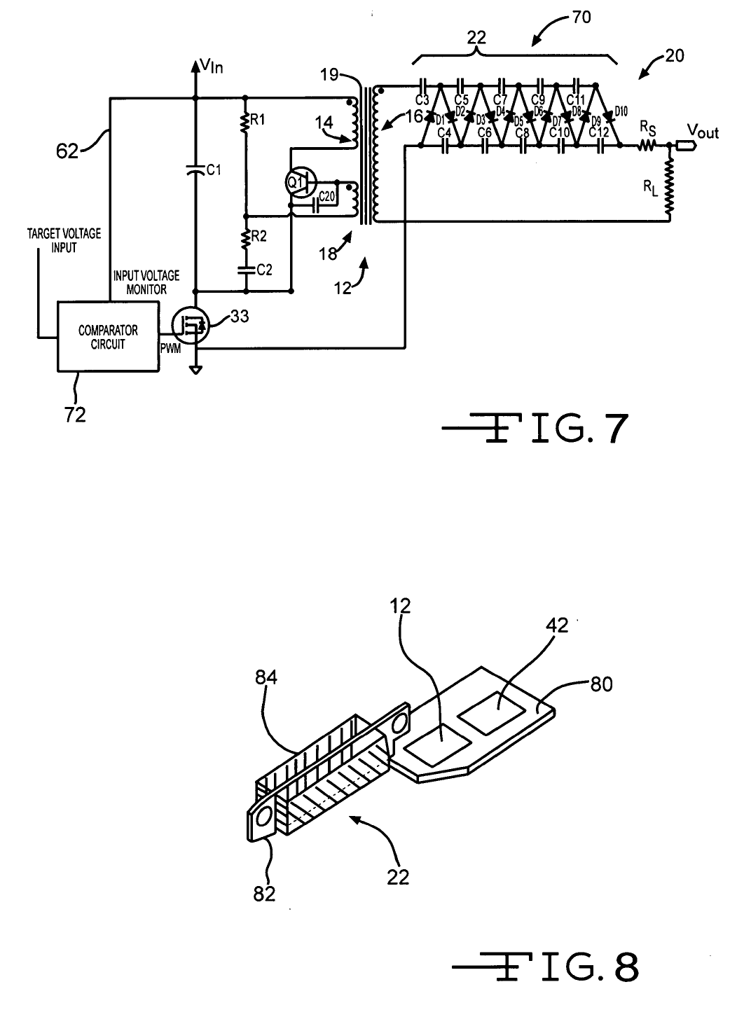

Another embodiment that includes input voltage regulation is shown generally at 60 in FIG. 6, where again components that are similar to components shown in the preceding figures have the same numerical identifiers. The HVPS 60 integrates pre-regulation into the architecture of the high voltage power supply. The microprocessor 42, or other controller, shown in the figure monitors voltage applied to the oscillator and transformer primary winding and compares this value to a prescribed set point. By modulating the FET 33, the effective input voltage can be regulated to the desired value, which in this case is 4 VDC. When this is the case, the invention contemplates adding an input voltage monitoring line that is shown by the line labeled 62 in FIG. 6. The input voltage monitoring line 62 connects the input voltage V_{IN} to a voltage monitoring port on the microprocessor 42. With a new set of batteries, the microprocessor 42 will lower the duty cycle to reduce the on-time compared to the off-time of the PWM to provide a consistent voltage input to the HVPS 60. The exact target voltage for the regulation is set within the capabilities of the battery source and the PWM generator within the microprocessor 42. The input voltage supplied to the HVPS 62 is monitored and used to dynamically adjust the ratio of the on-time to the off-time of the HVPS input voltage. As the battery ages and the battery voltage decreases, the microprocessor 42 will automatically increase the on-time and reduce the off-time of the PWM voltage in order to provide the HVPS a steady, consistent input voltage. Therefore, Vin is modulated by the microprocessor 42 via its PWM output and the FET 33.

Yet another embodiment is shown generally at 70 in FIG. 7 where the microprocessor 42 shown in FIG. 6 has been replaced by a comparator circuit 72 that may either be similar to the comparator circuit 32 shown in FIG. 3 or another conventional comparator circuit. As an example, the circuitry shown in FIGS. 5 through 7 will yield 25 kVDC when the input supply is 4 VDC.

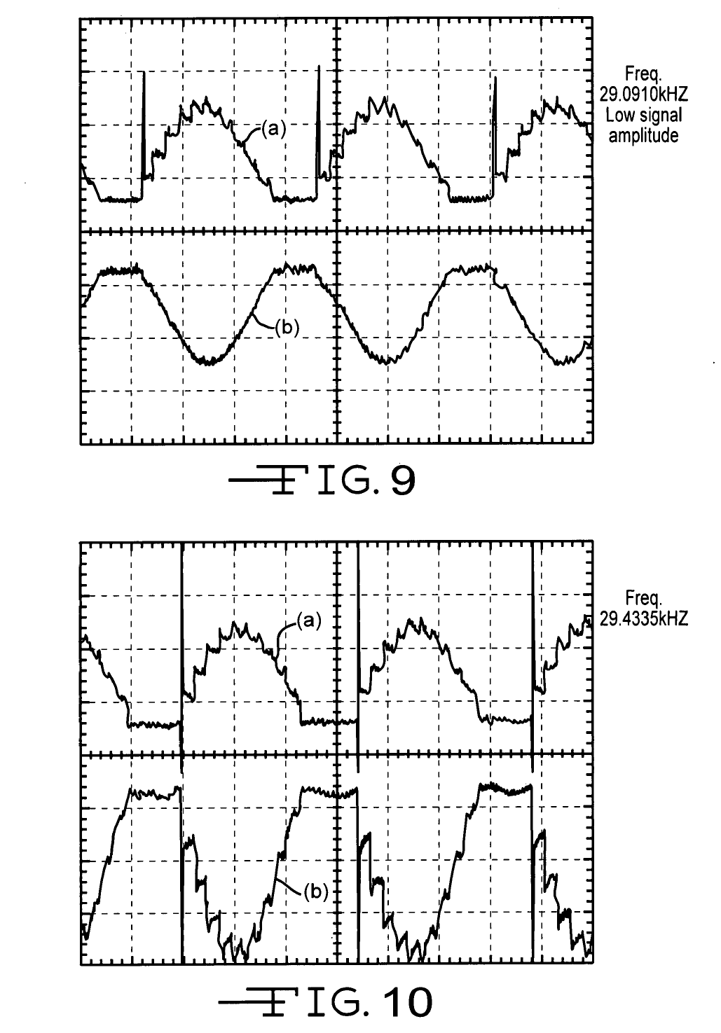

One possible configuration of the HVPS 40 described above is illustrated in FIG. 8, where components that are similar to components shown in FIG. 4 have the same numerical identifiers. As shown in FIG. 8, the flyback transformer 12 and the microcontroller 42 are mounted upon a primary circuit board 80 which would also carry the other components of the self-oscillating circuit. The Cockcroft-Walton voltage multiplier circuit 22 is mounted upon a secondary circuit board 82 that is attached to primary circuit board 80. While the secondary circuit board 82 is illustrated as being generally perpendicular to the primary circuit board 80, it will be appreciated that the invention also may be practiced with other orientations between the circuit boards 80 and 82. Potting 84 is applied over the Cockcroft-Walton voltage multiplier circuit 22 to insulate and protect the circuit components. The configuration illustrated in FIG. 8 allows a multiplicity of different Cockcroft-Walton voltage multiplier circuits to be attached to a common oscillator circuit, thus allowing for fabrication of HVPS having different output voltages from a minimum required parts inventory. It will be appreciated that the configuration shown in FIG. 8 also may be utilized for the HVPS 20 shown in FIG. 2, the HVPS 30 shown in FIG. 3 and the HVPS's 50, 60 and 70 shown in FIGS. 5 through 7.

The present invention provides a constant, low ripple very high output voltage from a low voltage source. In one application for the invention, a constant high voltage source is needed for consistent electrohydrodynamic spraying, also referred to as electric field effect technology (EFET) spraying. The high voltage output which is desirable for EFET spraying may range from 3 KV to 30 KV, and more particularly from 6 KV to 25 KV. However, the present invention may be practiced and is useful in applications requiring other high voltage output levels from less than 1KV to 50KV or greater. It is contemplated that the input voltage may be supplied by two or four AA batteries with maximum outputs of 3 and 6 volts, respectively, and minimum outputs of 2 and 4 volts, respectively. However, the HVPS circuits shown above also may utilize other input voltage values and other sources of power to include DC power supplies (not shown).

### EXAMPLES

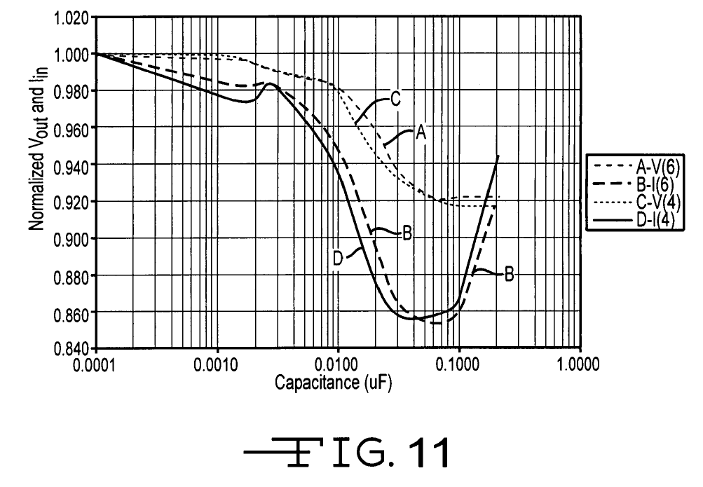

Referring now to the circuit HVPS 20 of FIG. 2, the inventors tested the circuit with a compensating capacitor C20 having a value of 0.033 uF. An oscilloscope screen of the transistor Q1 voltages is shown in FIG. 9, where the top trace is the collector signal monitored at point (a) and the bottom trace is the base signal at point (b). The compensating capacitor C20 was then removed and the test repeated, with the results shown in FIG. 10. It is clear that with the inclusion of the compensating capacitor C20, the amount of ripple was significantly reduced in the base signal (b) as well as in collector signal (a). More importantly, input current to the converter, which was at a fixed 4-volt input voltage, was reduced from 116 milliamperes (mA) to 99 mA, or by 14.66%, while the output voltage into a fixed impedance decreased from 24.4 kilovolts (kV) to 22.7 kV, or by 6.97%. Since the input voltage V_{IN} was the same for both cases, the decrease in input current indicates a reduced power draw, while the decrease in output voltage V_{OUT} indicates a decrease in output power. However, since the reduction of input power is greater, it is apparent the HVPS 20 with the compensating capacitor C20 is significantly more efficient than a power supply without a compensating capacitor.

The value of the shunting element, or elements, if more than one compensating capacitor is utilized, is determined by the intended operating frequency and the Self Resonant Frequency (SRF) of the power supply. The shunt needs to present reasonably low impedance at SRF but not attenuate the self-oscillation frequency designed into the overall circuit. A single capacitance, as implemented in this design, offers the lowest cost, but a compromise must be struck between removing undesired signals and passing those that are intended for normal operation. Typically, the two frequencies are at least an order of magnitude apart from each other so that simple filtering can be employed. Greater performance can be gained with more complex shunting networks but at a greater cost for the network itself.

Determining the specific values through analytical methods can be quite difficult, since some of the critical parameters are challenging to measure. Furthermore, the determination process may be influenced by the desired outcome of the designer. For example, the data in FIG. 11 were collected and charted for the circuit configuration shown in FIGS. 1 and 2. The Y axis is normalized Vout and Iin, and the X axis is Capacitance in uF.

FIG. 11 shows the relationship of normalized output voltage and input current at fixed input voltages of four and six volts, respectively, as a function of the compensation capacitance value. While supply current appears to be minimized when the shunt capacitance is between 0.03 and 0.1 uF for this circuit configuration, the output voltage also has experienced a reduction. On the other hand, if the other goal is to maintain as high of an output voltage as practical, then these data suggest that the compensation capacitance should be less than 0.01 uF. By taking the ratio of normalized output voltage to normalized input current, a maximum is observed around 0.03 to 0.035 uF. Since a standard capacitor value is 0.033 uF, this value would be selected to yield optimum performance. A key to the right side of the figure identifies the voltage and current curves A, B, C and D.

For other transformers that may be used in the design, quantitative values of the curves are expected to vary, but the general principles will remain the same. With the teachings disclosed herein the practitioner skilled in the art can readily determine the proper value for the compensating capacitor.

As has been described above, FIG. 9 illustrates the base and collector signal responses of the self-oscillating power supply with a compensating capacitor C20 in place. According to FIG. 11 and calculations of the input and output powers, a value of 0.033 uF for C20 yields a maximum efficiency. However, FIG. 9 shows voltage spikes are present at the point when transistor Q1 transitions out of saturation and becomes less conducting. These high frequency spikes can be a source of undesired Electro-Magnetic Interference (EMI) that could disrupt the operation of circuits in proximity to the power supply or could radiate or conduct to other devices that may be sensitive to EMI. Governing bodies, like the Federal Communications Commission (FCC) place limitations on the amount of acceptable EMI that may be generated by a product.

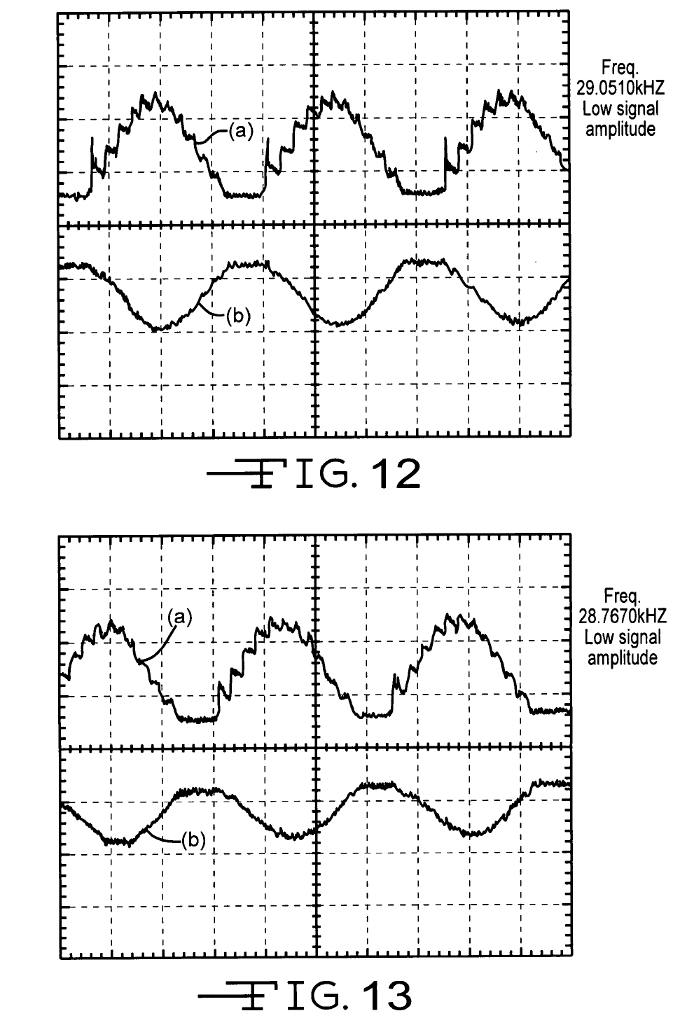

FIGS. 12 and 13 illustrate the impact on the circuit performance when the compensating capacitor C20 is further increased to values of 0.068 and 0.10 uF, respectively. As the capacitor is increased beyond the value for optimum efficiency, the reduction in noise is significant with attenuation of the voltage spikes present at the point in FIG. 9 when transistor Q1 transitions out of saturation and becomes less conducting. Any further attenuation of the voltage spikes is nearly imperceptible in FIG. 13. The output voltage for both of these configurations is 22.4 kV, and the input currents with a 4-volt power source are 100 and 101 mA, respectively for FIGS. 12 and 13. Hence, while the overall efficiency of the HVPS appears to be only slightly affected, the impact of the compensating capacitor on the noise generated by the supply is significant.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope. Thus, the invention also can be broadly applied to high side drivers, where the switching transistor is placed between the DC input power source and the primary winding of the transformer (not shown), as well as to field effect transistors drivers or switching devices. The net effect is that the switching device does not promote the self-resonance of the transformer, and the associated power loss is minimized.

What is claimed is:

1. A high voltage power supply comprising:
a flyback transformer having a primary winding and a feedback winding, said primary winding having a first end adapted to be connected to a power supply;
a switching device connected between a second end of said primary winding and ground, said switching device having a control port connected to a first end of said feedback winding; and
a compensation capacitor connected between said switching device control port and ground.

2. The power supply according to claim 1 wherein said flyback transformer includes a secondary winding having more turns than said primary winding whereby an output voltage is induced across said secondary winding that is greater than a voltage applied to said primary winding.

3. The power supply according to claim 3 wherein a Cockcroft-Walton voltage multiplier circuit is connected across said flyback transformer secondary winding.

4. The power supply according to claim 3 wherein said switching device is a transistor.

5. A high voltage power supply comprising:
a flyback transformer having a primary winding and a feedback winding, said primary winding having a first end adapted to be connected to a power supply, said flyback transformer also having a secondary winding having more turns than said primary winding whereby an output voltage is induced across said secondary winding that is greater than a voltage applied to said primary winding;
a first switching device connected to a second end of said primary winding second end, said first switching device having a control port connected to a first end of said feedback winding;
a second switching device connected between said first switching device and ground, said second switching device operable to interrupt current flow to said first switching device to regulate said output voltage; and
a compensation capacitor connected between said first switching device control port and said second switching device.

6. The power supply according to claim 5 further including feedback of a feedback voltage that is proportional to said output voltage to a voltage regulation device, said voltage regulation device connected to said second electronic switch and operable to selectively cause said second switching device to interrupt current flow to said first switching device.

7. The power supply according to claim 6 wherein said first electronic switch is a transistor and said second electronic switch is a field effect transistor.

8. The power supply according to claim 7 wherein said voltage regulating device includes a microcontroller that is operable to regulate said output voltage to maintain a target voltage.

9. The power supply according to claim 8 wherein said microcontroller is also operable to set said target voltage.

10. The power supply according to claim 8 wherein said microcontroller is operable to generate a pulse width modulated voltage that having a duty cycle that is a function of said feedback voltage, said microcontroller operable to apply said pulse width modulated voltage to a gate terminal of said field effect transistor to regulate said output voltage.

11. The power supply according to claim 10 wherein said microcontroller also monitors the input voltage and is operable to modify said duty cycle of said pulse width modulated voltage to compensate for varying input voltages.

12. The power supply according to claim 7 wherein said voltage regulating device includes a comparator that compares said feedback voltage to a reference voltage.

13. The power supply according to claim 12 wherein said comparator includes an operational amplifier.

14. The power supply according to claim 4 further including a voltage regulation device connected between said first end of said primary winding and a power supply.

15. The power supply according to claim 4 wherein the value of said compensating capacitor is selected to optimize efficiency of the power supply.

16. The power supply according to claim 4 wherein the value of said compensating capacitor is selected to minimize any Electro-Magnetic interference generated by the power supply.

17. A method for operating a high voltage power supply comprising the steps of:
(a) providing a flyback transformer having a primary winding and a feedback winding, the primary winding having a first end connected to a power supply, the flyback transformer also having a secondary winding having more turns than the primary winding;
a switching device connected between a second end of the primary winding and ground, the switching device having a control port connected to a first end of the feedback winding; and
a compensation capacitor connected between the switching device control port and ground;
(b) applying a voltage to the switching device to cause the switching device to conduct an electric current;
(c) inducing voltages in the secondary winding and the feedback winding, the feedback winding voltage with the electric current; and
(d) applying the voltage induced in the feedback winding to the switching device to cause the switching device to stop conducting the electric current;
(e) allowing the induced voltages in the secondary and feedback windings to collapse whereby the switching device begins to conduct an electric current again.

18. The method according to claim 17 wherein a portion of the secondary winding voltage is feedback to a voltage regulating device that is operative to regulate the power supply to maintain the output voltage within a range of voltages for various loads.
